(19) United States
(12) Patent Application Publication
(10) Pub. No.: US 2012/0226757 A1
(43) Pub. Date: Sep. 6, 2012

(54) Location Filtered Messaging

(76) Inventors: Keith McFarland, Annapolis, MD (US); Doug Kesser, Mooresville, NC (US); Joseph Pohutsky, Annapolis, MD (US); Dara Ung, Harwood, MD (US)

(21) Appl. No.: 13/396,029

(22) Filed: Feb. 14, 2012

Related U.S. Application Data
(60) Provisional application No. 61/457,325, filed on Mar. 1, 2011.

(51) Int. Cl. G06F 15/16

(52) U.S. Cl. 709/206

(57) ABSTRACT

A method enabling a mobile/non-mobile device to perform location-based message filtering against a proposed list of message recipients. Identifiers indicating location characteristics are embedded in the body of a message prior to transmission. Following message transmission, location characteristics are identified/extracted from a location filtered message by a location filtering engine. Location characteristics may indicate a geographic location (e.g. address, zip code, etc.), a POI, or a boundary centered at a geographic location/POI. The location filtering engine attains location information for each device referenced in a proposed distribution list. Attained location information for each device is compared against location characteristics extracted from a corresponding location filtered message. A formal distribution list is compiled, containing all devices in the proposed distribution list with location information matching location criteria embedded in the corresponding filtered message. The present invention applies to any messaging technology that does not encrypt the actual body of a message.

The present application claims priority from U.S. Provisional Appl. No. 61/457,325, entitled “Location Filters via Messaging” to McFarland et al., the entirety of which is explicitly incorporated herein by reference.

### BACKGROUND OF THE INVENTION

1. Field of the Invention

This invention relates generally to wireless telecommunications. More particularly, it relates to wireless telecommunications, text and multi-media messaging, machine to machine (M2M), telematics, and location based messaging.

2. Background of Related Art

The incorporation of tracking technology in today's handheld mobile devices has led to a vast emergence of location based services (LBS). Location based services (LBS) present an advantageous addition to conventional messaging services. For instance, location based services (LBS) enable consumers to send a message based on the location of a potential recipient's mobile device. Hence, tracking technology enables, e.g., a subscriber to transmit a message to a user having a mobile device at a particular location, or to a user having a mobile device within a predetermined proximity to a particular location.

In an attempt to compete in today's corporate-driven world, businesses often invest and engage in an abundance of advertising and marketing schemes. Businesses additionally seek a variety of innovative strategies and services to simplify and improve upon the efficiency of internal business operations.

Location based services (LBS) are particularly useful for business, contributing to both internal and external business endeavors. For instance, location based messaging facilitates a business to target promotional information to relevant consumers, and/or corporate information to employees, based on potential recipients' proximity to a particular site of interest. Moreover, location based services (LBS) enable a business to engage in location based advertising via transmission of promotional/marketing messages. Messages for location based advertising are transmitted using location filters against a corporate customer-database or contact list. Location filters enable businesses to define a geographic boundary about a particular location (e.g., a site of a business, a promotional event, etc.) and transmit a message to all devices present within that boundary, hence targeting potential consumers.

FIG. 11 portrays an illustrative example of geographic boundaries portrayed on a map.

As depicted in FIG. 11, a circle boundary 10 may be established about a central geographic location for targeted distribution of messages to mobile devices within that circle boundary 10. A message may also be transmitted to recipient devices in a distribution list that are located within a predefined, publically acknowledged, non-regular physical boundary 20 (e.g., a particular zip code).

Various approaches may be used to determine the location of a destination device, depending upon the information that is available. Location information for an electronic device may be requested from one of a multitude of location sources (e.g. a network operator, a web service, or any other suitable source of location information).

Location based messaging is rapidly emerging as an invaluable advertising tool as the magnitude and aptitude of location based services (LBS) continues to grow. However, existing technology for location based messaging is limited to the utilization of a web page with mapping technology, and a selection of message recipients.

### SUMMARY OF THE INVENTION

In accordance with the principles of the present invention, a method enabling a mobile/non-mobile device to perform location based message filtering against a selected set of message recipients, comprises a Location Filtering Engine. The Location Filtering Engine utilizes location based services (LBS) to filter a message distribution list based on the current physical location of each destination device referenced within the list. The Location Filtering Engine transmits messages to those destination devices in the distribution list that have a location adhering to a predefined location filter.

The Location Filtering Engine begins the filtering process by extracting embedded location characteristics from a transmitted location filtered message, in accordance with the principles of the present invention. The Location Filtering Engine subsequently applies extracted location characteristics as a location filter against an identified set of potential message recipients.

In accordance with the principles of the present invention, the Location Filtering Engine attains a location for each device referenced in a proposed message distribution list. Attained location information for each device is compared against location characteristics extracted from the location filtered message in affiliation with the distribution list. Based upon this comparison, the Location Filtering Engine composes a formal message distribution list from the proposed message distribution list. The formal distribution list contains each mobile device referenced in the proposed distribution list, with a current physical location that satisfies the location filter defined in the location filtered message. The Location Filtering Engine subsequently transmits the location filtered message to each device referenced in the formal distribution list.

A set of configurable keyword identifiers are defined to mark the start and/or stop of the location characteristic portion of a message, in accordance with another aspect of the present invention. Configurable keyword identifiers enable a Location Filtering Engine to identify that a message contains embedded location characteristics.

Moreover, the Location Filtering Engine, in accordance with yet another aspect of the present invention, filters a proposed list of destination devices in light of at least one of a particular geographic location, a particular point of interest (POI), or a defined geographic boundary centered at a particular geographic location and/or point of interest (POI).

In accordance with another embodiment of the present invention, one method of embedding location characteristics in to a message for transmission comprises a Message Add In feature.

Additionally, location based message filtering may also be leveraged via a traditional web portal interface with mapping technology, in accordance with yet another embodiment of the present invention.

### BRIEF DESCRIPTION OF THE DRAWINGS

Features and advantages of the present invention will become apparent to those skilled in the art from the following description with reference to the drawings, in which:

FIG. 1 depicts an exemplary location filtered message transmission process using a Location Filtering Engine, in accordance with the principles of the present invention.

FIG. 2 depicts an exemplary location filtering process performed on the Location Filtering Engine, in accordance with the principles of the present invention.

FIG. 3 depicts an illustrative example of a message containing embedded location characteristics, in accordance with the principles of the present invention.

FIG. 4 depicts a second illustrative example of a message containing location characteristics, in accordance with the principles of the present invention.

FIG. 5 depicts a third illustrative example of a message containing location characteristics, in accordance with the principles of the present invention.

FIG. 6 depicts an exemplary email message containing embedded location characteristics, in accordance with the principles of the present invention.

FIG. 7 portrays an exemplary Message Add In feature, in accordance with the principles of the present invention.

FIG. 8 depicts an exemplary Location Based Message Composition screen hosted on a web portal interface, in accordance with the principles of the present invention.

FIG. 9 depicts an exemplary Location Selection screen for selecting a geographic boundary using mapping technology via web portal interface, in accordance with the principles of the present invention.

FIG. 10 depicts an exemplary Location Selection screen for selecting a point of interest (POI) using mapping technology via web portal interface, in accordance with the principles of the present invention.

FIG. 11 portrays an illustrative example of geographic boundaries portrayed on a map.

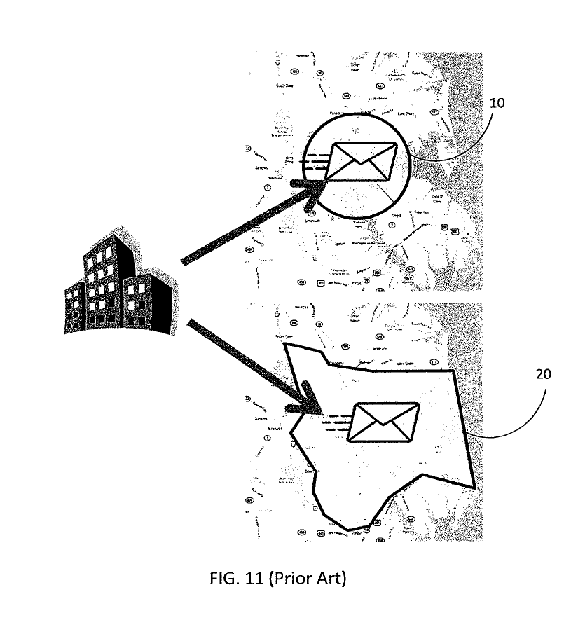

### DETAILED DESCRIPTION OF ILLUSTRATIVE EMBODIMENTS

The present inventors have appreciated that consumers and businesses desire a means to send messages with location filters against a selected set of message recipients, in a manner that does not involve a complicated web portal interface with mapping technology.

Current message transfer protocols utilized by mobile/non-mobile devices (e.g., Short Message Service (SMS), Multimedia Messaging Service (MMS), and the web for mobile devices, as well as Short Message Transfer Protocol (SMTP), Wireless Communication Transfer Protocol (WCTP), Short Message Peer to Peer protocol (SMPP), Simple Network Paging Protocol (SNPP), Instant Messaging, etc. for non-mobile devices) necessitate a means to submit location filtering characteristics for destination devices without a complex web portal interface.

The present invention enables a mobile or non-mobile device to perform location based message filtering via the employment of a Location Filtering Engine. The Location Filtering Engine permits a consumer/enterprise to send a message to devices that are within, or soon to be within, the boundaries of particular geographic locations.

In accordance with the principles of the present invention, location characteristics are embedded in a message by a user prior to transmission. Following message transmission, location characteristics are subsequently extracted from the message by the Location Filtering Engine. Extracted location characteristics are then used to filter a proposed list of message recipients, supplied in the message destination field by the message originator. Location filtering performed by the Location Filtering Engine results in a formal list of message recipients for targeted message distribution.

The Location Filtering Engine determines a location/boundary for targeted message distribution based on the contents of a transmitted message. Thus, the body of a location filtered message must remain in clear text throughout transmission, to enable the Location Filtering Engine to accurately identify embedded location characteristics. Hence, the present invention may be used in conjunction with any messaging technology that does not encrypt the body of a message.

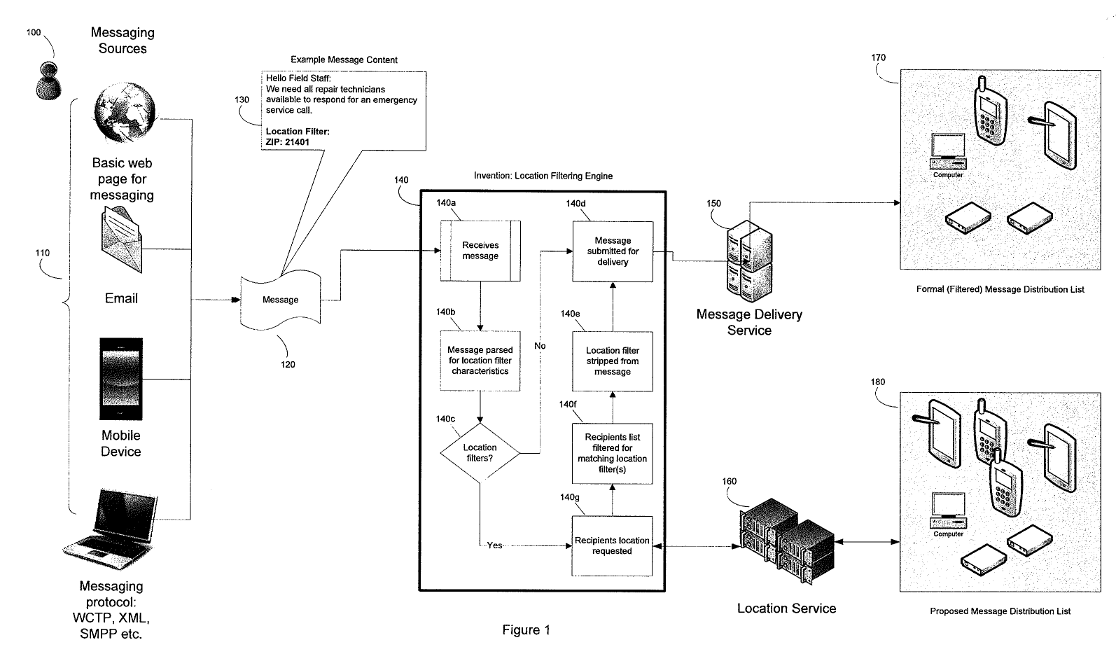

FIG. 1 depicts an exemplary location filtered message transmission process using a Location Filtering Engine, in accordance with the principles of the present invention.

As depicted in FIG. 1, a user deploying any messaging service that does not encrypt the actual body of a message 110, (e.g., a web page, email, a mobile device, messaging protocols such as WCTP, XML, SMPP, etc.), composes a message 120 via user device 100. The message originator via user device 100, inserts a list of potential message recipients in to the destination address field of the message 120, in a manner corresponding to the particular messaging technology that is being used.

The message originator determines that the message is only relevant to devices that are located within or outside a particular geographic location. Thus, the message originator via user device 100, inserts location specific information 130 into the body of the location filtered message 120.

The location filtered message 120 is transmitted from the user device 100 and routed to the Location Filtering Engine 140, as depicted in FIG. 1. The Location Filtering Engine 140 receives the location filtered message 140a and parses the message contents 140b for indication of embedded location characteristics 130.

If location/keyword identifiers are not discovered 140c within the body of the message 120 received on the Location Filtering Engine 140, the message 120 is transmitted 140d via conventional message routing procedures 150, to each destination device identified in the proposed message distribution list 180.

Alternatively, if location/keyword identifiers are discovered 140c within the body of the message 120 received on the Location Filtering Engine 140, the Location Filtering Engine 140 extracts the discovered location characteristics 130. The Location Filtering Engine 140 subsequently stores the extracted location characteristics 130 so that extracted location information may be applied as a location filter against proposed message recipients identified in the message destination field.

The Location Filtering Engine 140 subsequently requests a location for each proposed destination device 140g from one of a multitude of external location sources 160 (e.g., a network operator, a web service, etc.). The location source 160 returns requested location information to the Location Filtering Engine 140.

A current location for each potential recipient device is received on the Location Filtering Engine 140 and compared against the location filter 140f defined in the location filtered message 120. Based upon location comparison and various message characteristics, a device is either included or excluded in the formal list of devices for message distribution 120.

Once the proposed distribution list is filtered 140f in light of supplied location criteria 130, the Location Filtering Engine 140 recomposes the original message, sans location characteristics 140e. The Location Filtering Engine 140 subsequently transmits 140d the message 120 to devices indicated in the formal distribution list 170, via conventional routing procedures 150.

The actual filtering of a recipient distribution list is performed by a Location Filtering Module on the Location Filtering Engine.

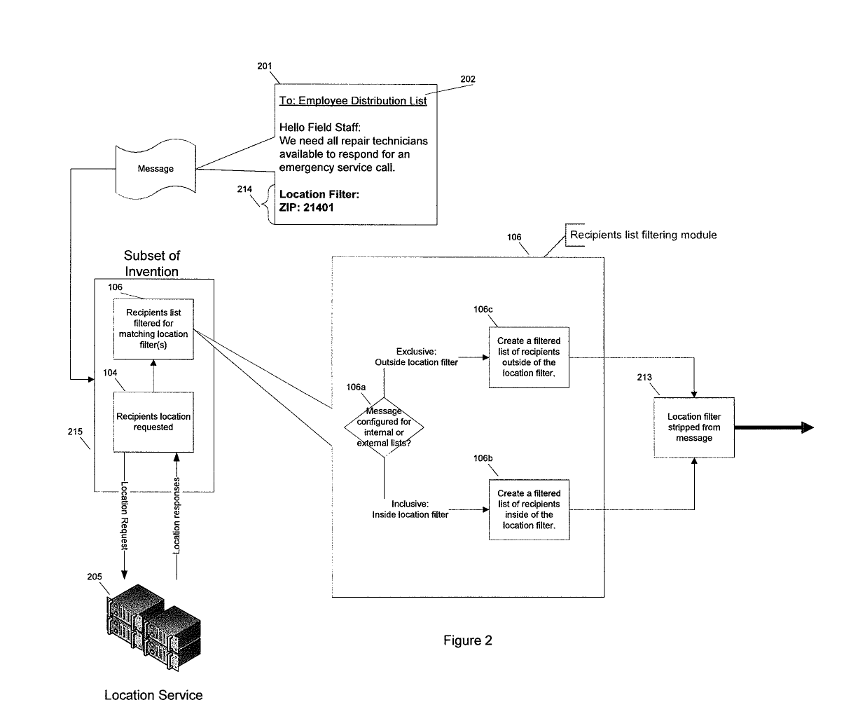

FIG. 2 depicts an exemplary location filtering process performed on the Location Filtering Engine, in accordance with the principles of the present invention.

As depicted in FIG. 2, a message 201 containing embedded location characteristics 214 is received on the Location Filtering Engine 215. The Location Filtering Engine 215 first identifies and extracts location/keyword identifiers 214 from the transmitted message 201. Extracted location/keyword identifiers 214 are subsequently stored so that they may be used as location filters against the proposed distribution list 202 indicated in the message destination field.

Identification of location characteristics in a message triggers the Location Filtering Engine 215 to request a location 104 for each device referenced in the proposed distribution list 202. The Location Filtering Engine 215 requests location information from a conventional location source 205. The conventional location source subsequently returns location coordinates for each proposed destination device to the Location Filtering Engine 215. The Location Filtering Engine 215 then initiates the filtering process 106 to be performed on the Location Filtering Module 106a-c.

The exemplary Location Filtering Module 209 depicted in FIG. 2 first distinguishes amongst proposed destination devices, by defining each device as being either ‘inside’ or ‘outside’ the location filter 207 defined in the location filtered message 201. Once each device is identified as either ‘inside’ or ‘outside’, the Location Filtering Module 209 is able to transform the proposed distribution list 202 in to a formal distribution list 208.

The Location Filtering Engine 215 may be preconfigured or instructed by message contents to establish an inclusive formal distribution list. An inclusive formal distribution list contains all recipient devices in the proposed distribution list 202 that are located within the boundary 106a defined by the location filter. Thus, an inclusive formal distribution list is built containing all devices defined by the Location Filtering Module as being ‘inside’ the defined location filter 106b.

Alternatively, the Location Filtering Engine 215 may be preconfigured or instructed by message contents to establish an exclusive formal distribution list. An exclusive formal distribution list contains all recipient devices in the proposed distribution list 202 that are not located within the boundary 106a defined by the location filter. Thus, a formal distribution list is built containing all devices defined by the Location Filtering Module as being ‘outside the defined location filter 106c.

Once the formal distribution list is composed, the location filtered message is submitted for delivery 213, sans embedded location characteristics.

User-defined location characteristics, in accordance with the principles of the present invention, are comprised as a series of configurable keyword identifiers and location identifiers. Configurable keyword identifiers are defined to mark the start and/or stop of location characteristics embedded within the body of a location-filtered message (e.g., “LOCATION INFORMATION START”, “END”, etc.). Predefined keyword identifiers (e.g. a predefined header and/or trailer) embedded in a message, trigger the Location Filtering Engine to parse the contents of that message, to detect embedded location characteristics.

Configurable keyword identifiers may additionally be used to identify the types of geographic information being provided within the location filter portion of a message (e.g., ‘Address’, ‘Latitude’, ‘Longitude’, ‘Radius’, ‘Diameter’, ‘ZIP’, “County’, “City’, ‘Miles’, ‘Kilometers’, ‘Meters’, “Feet’, etc.). Keyword identifiers may preferably be user-defined. Hence, the Location Filtering Engine preferably stores custom user-defined geographic shapes that are input to the system via an input mechanism (e.g. a GUI interface).

A location identifier may be a full street address, a city and state, a state, a zip code, latitude/longitude coordinates, a user-defined point-of-interest (POI), a physical/logical name, or any combination thereof. A point of interest, for example, can be a landmark, a shopping center, a business establishment, a park, etc.

A circle boundary may optionally be defined about a particular location by inserting a central location in to a message, accompanied by a radius/diameter value, via appropriate keyword/location identifiers. A circle boundary having a given radius/diameter is established about a given central location for targeted message distribution.

Location and keyword identifiers embedded in the body of a message consume some of the existing message payload.

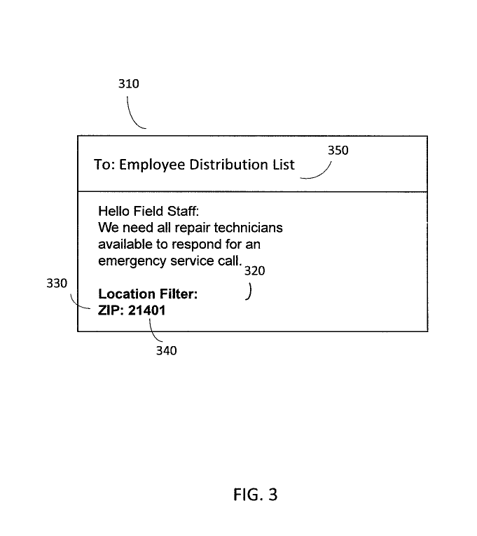

FIG. 3 depicts an illustrative example of a message containing embedded location characteristics, in accordance with the principles of the present invention.

In particular, the exemplary message 310 depicted in FIG. 3, contains a configurable keyword identifier, “Location Information,” 320 to tag the message as containing location filters. The message 310, depicted in FIG. 3, additionally contains the keyword identifier “ZIP” 330 and the location identifier “21401”, 340 to identify a particular zip code for location filtered message distribution. A zip code embedded within the contents of a location filtered message corresponds to a predefined physical boundary. Thus, the location identifier, “21401”, 340 is a keyword depicting a predefined geographic shape. A zip code embedded within a location filtered message may preferably be used to depict a user-defined geographic shape or a publically acknowledged geographic shape.

The message depicted in FIG. 3 is transmitted to each destination device that is referenced in Employee Distribution List 350 and located within the predefined physical boundary corresponding to zip code 21401.

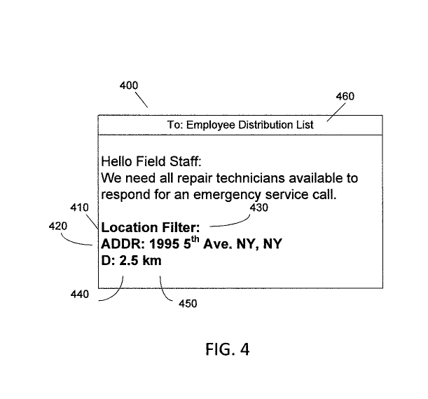

FIG. 4 depicts a second illustrative example of a message containing location characteristics, in accordance with the principles of the present invention.

In particular, the exemplary message 400 depicted in FIG. 4, contains a configurable keyword identifier, “Location Information,” 410 to tag the message as containing location filters. The message 400 depicted in FIG. 4 additionally contains the keyword identifier “ADDR” 420 and the location identifier “1995 5^{th} Ave. NY, N.Y.”, 430 to identify a particular address for location filtered message distribution. An address embedded within the contents of a location filtered message corresponds to a specific geographic point on a map.

The exemplary message 400 depicted in FIG. 4 also contains the keyword identifier, “D”, 440 signifying a diameter, with a value of 2.5 km 450. A geographic location accompanied by a diameter/radius value in a location filtered message, creates a circle boundary having a diameter/radius, as defined within the message, centered about a geographic location, as defined within the message. Thus, the exemplary message 400 depicted in FIG. 4 is transmitted to each destination device that is referenced in Employee Distribution List 460, and located within a circle boundary having a diameter of 2.5 km, centered at a geographic point corresponding to address 1995 5^{th} Ave. NY, N.Y.

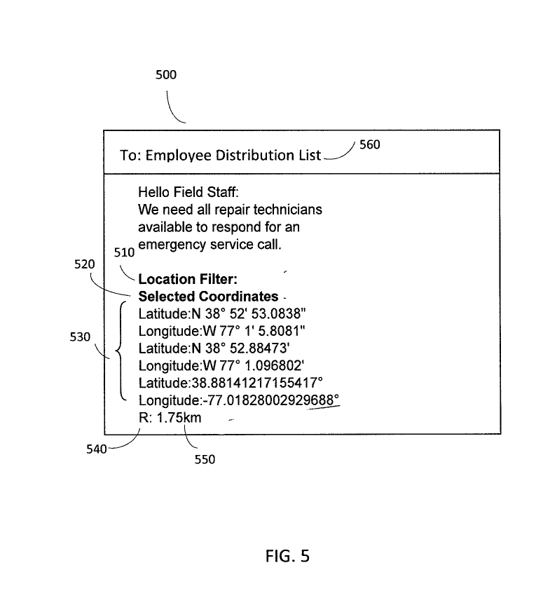

FIG. 5 depicts a third illustrative example of a message containing location characteristics, in accordance with the principles of the present invention.

In particular, the exemplary message 500 depicted in FIG. 5, contains a configurable keyword identifier, “Location Information,” 510 to tag the message as containing location filters. The message depicted in FIG. 5 additionally contains the keyword identifier “Selected Coordinates” 520 to depict that a combination of latitude/longitude coordinates 530 will follow. Latitude/longitude coordinates that are embedded within the contents of a location filtered message correspond to specific geographic points on a map.

The exemplary message 500 depicted in FIG. 5 also contains the keyword identifier, “R”, 540 signifying a radius, with a value of 1.75 km 550. Thus, the exemplary message depicted in FIG. 5 is transmitted to each destination device that is referenced in Employee Distribution List 560, and located within a circle boundary having a radius of 1.75 km, centered at each latitude/longitude combination 530 identified in the “Selected Coordinates” 520 portion of the message 500.

A location filtered message may also contain a configurable header/trailer combination to identify the portion of the message that contains key location information.

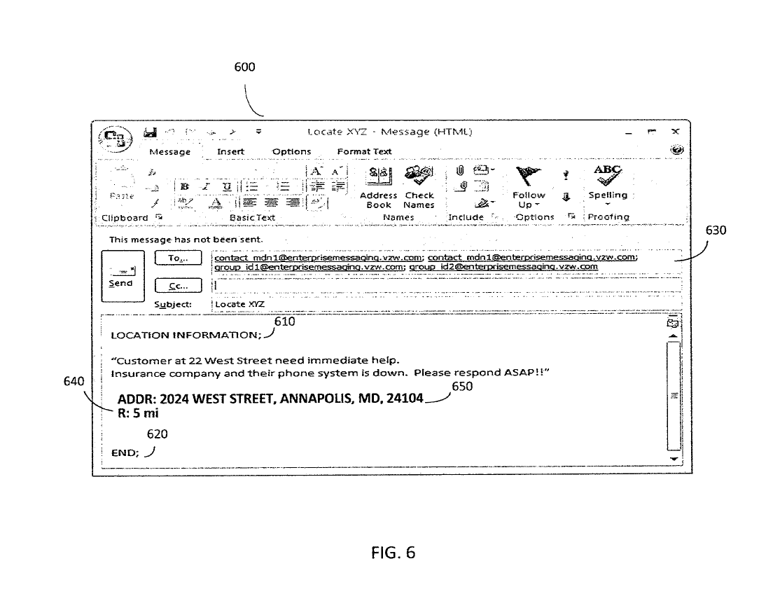

FIG. 6 depicts an exemplary email message containing embedded location characteristics, in accordance with the principles of the present invention.

The email 600 depicted in FIG. 6 contains a configurable header/trailer combination. The header, “LOCATION INFORMATION”, 610 tags the message as containing location filters and triggers the Location Filtering Engine to begin parsing the body of the message for embedded location characteristics. The Location Filtering Engine parses the location filtered message 600 until it reaches the keyword trailer “END” 620. The email depicted in FIG. 6 is transmitted to each device identified within the destination address portion 630 of the message 600, that is located within a circle boundary having a radius of 5 mi 640, centered at a geographic location corresponding to address 2023 West Street, Annapolis, Md., 24104 650.

Location characteristics may be inserted into a message manually by a user via a user device.

Alternatively, in a particular embodiment of the present invention, a Message Add In feature may be utilized to embed location characteristics into a message for transmission. A Message Add In feature supports the ease of use of location based message filtering, in accordance with the present invention. Particularly, a Message Add In feature provides more structure and increased accuracy for the input of data into a message. A message service supporting the inventive location filtered messaging solution, preferably provides a Message Add In icon on a message composition page. A Message Add In icon on a message composition page may optionally be selected by a user device to insert location characteristics into a message for transmission.

Once a Message Add In icon is selected by a user via a user device, a Message Add In form is presented to the user device containing defined fields to be populated.

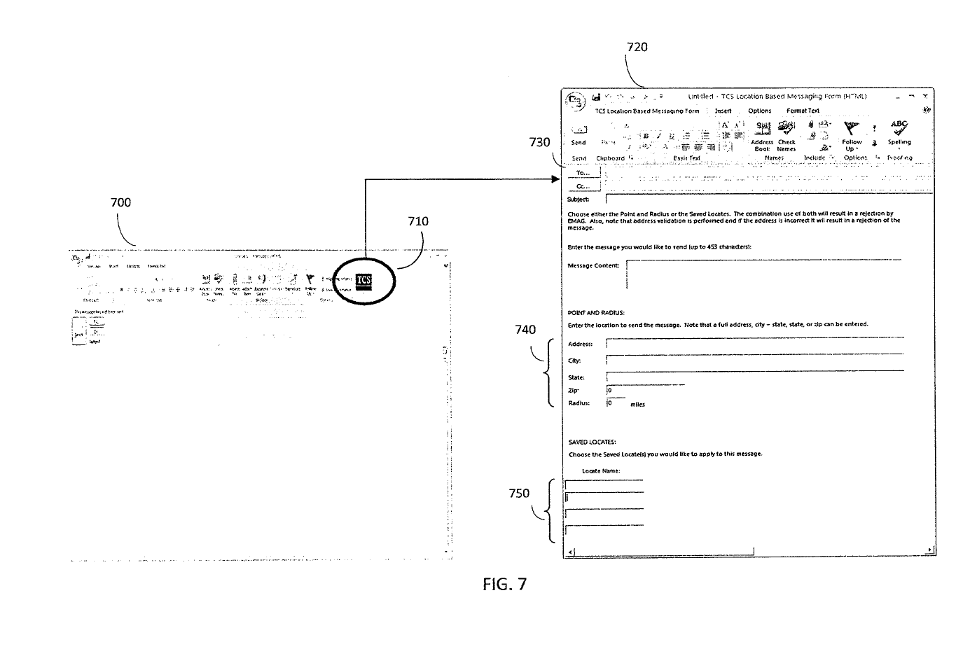

FIG. 7 portrays an exemplary Message Add In feature, in accordance with the principles of the present invention.

As depicted in FIG. 7, the Message Add In icon 710 on the email message composition page 700, presents a Message Add In pop up form 720 to a user device when selected by a message originator. The Message Add In form 720 preferably contains a destination field 730 to insert a proposed distribution list, and a set of location fields 740, to input desired location characteristics. A Message Add In form 720 also preferably contains a set of ‘Saved Locates’ fields 750 to insert predefined/previously saved location characteristics, for additional ease of use.

The form 720 depicted in FIG. 7 compiles a message, in accordance with conventional message composition procedures, and subsequently embeds defined location characteristics in to the body of the message. The composed location filtered message is transmitted upon user request, according to traditional routing procedures, in accordance with the particular messaging protocol that is being used (e.g., Simple Message Transfer Protocol (SMTP), as depicted in FIG. 7).

In an alternative embodiment of the present invention, location characteristics may also be inserted into a message via web portal interface. A web portal interface, in accordance with the principles of the present invention, enables a user to select a geographic location for message transmission via mapping technology. A geographic boundary selected on a map is transformed into geographic identifiers recognized by the Location Filtering Engine. Geographic identifiers are subsequently embedded into the body of a message. The present invention then treats the transmitted message as it would any other location filtered message.

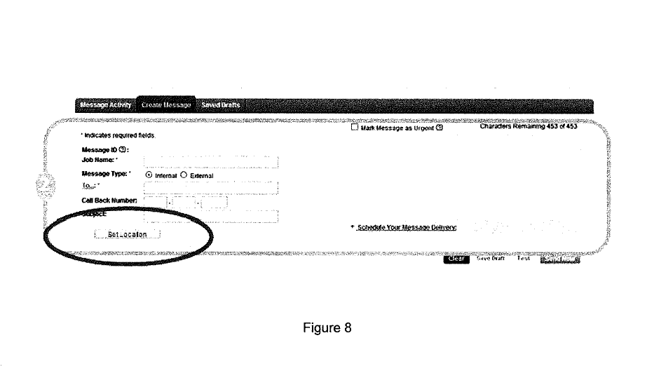

FIG. 8 depicts an exemplary Location Based Message Composition screen hosted on a web portal interface, in accordance with the principles of the present invention.

Once an end user has composed the body of a message using a location based message composition screen, 800 as depicted in FIG. 8, the user may select the “Set Location” icon 810 to apply location characteristics to the message.

Selecting the “Set Location” icon 810 navigates the user to a Location Selection screen with web mapping technology (e.g. Bing Maps functionality), hosted on a web portal interface. Mapping technology enables a user to search for a particular location on a map.

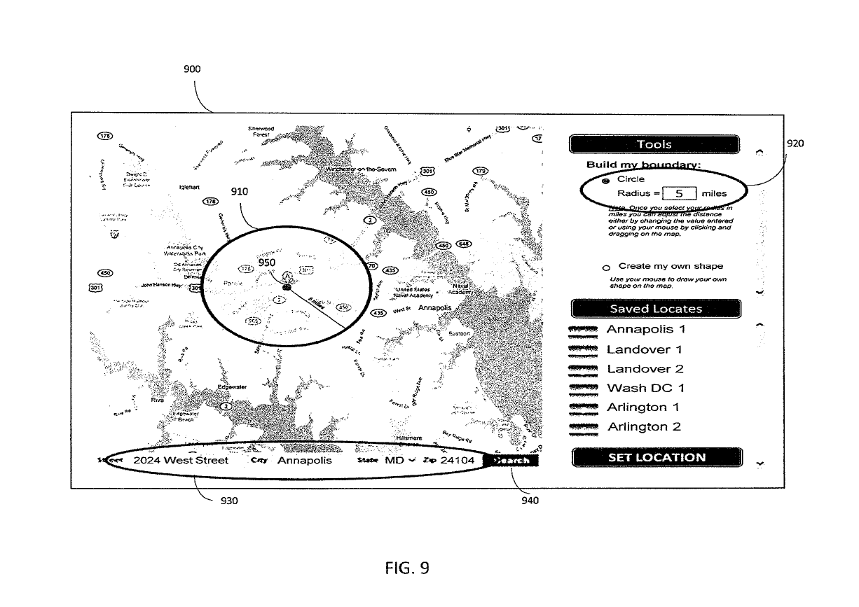

FIG. 9 depicts an exemplary Location Selection screen for selecting a geographic boundary using mapping technology via web portal interface, in accordance with the principles of the present invention.

A user may enter a full street address, a city and state, a state, or a zip code, corresponding to a location within the United States, in to the search fields 930 located on the “Location Selection” screen 900, as depicted in FIG. 9. The user may select the “Search” icon 940 to perform a Locate on search criteria entered in the search fields 930. Once a desired location 950 is identified on the map, a user may optionally define a boundary 910 centered at that identified location 950. The present invention supports circle boundaries defined about a central location. To create a circle boundary for message transmission, a user must first select a location on the map 950 and then enter a desired radius in to the radius field 920 on the “Location Selection” screen 900, as depicted in FIG. 9.

Location filtered messaging via web portal interface also enables a geographic area to be refined through points of interest (POIs). Rather than selecting a specific location for location filtered message distribution, a user may alternatively search for a particular point of interest (POI).

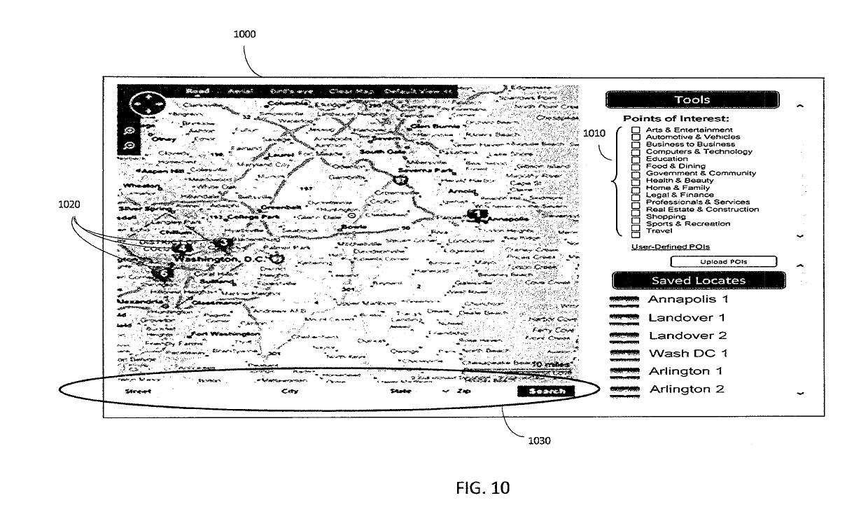

FIG. 10 depicts an exemplary Location Selection screen for selecting a point of interest (POI) using mapping technology via web portal interface, in accordance with the principles of the present invention.

A point of interest (POI) may be viewed as a layer on a map, as depicted by the markers 1020 on the exemplary map depicted in FIG. 10. The location of an icon on a map 1020 is representative of the location of the corresponding point of interest (POI). A user can search for a point of interest (POI) based on user selected search criterion 1030. Specific points of interest (POIs) may be toggled on and off by checking/unchecking the boxes pertaining to them 1010. Geo-fencing may optionally be established around a point of interest (POI), if desired.

The present invention has particular applicability to consumers and businesses in any space that requires or prefers the use of secure messaging.

More particularly, the present invention has particular applicability to telematics, workforce management, health care providers, mobile marketing and financial service organizations.

While the invention has been described with reference to the exemplary embodiments thereof, those skilled in the art will be able to make various modifications to the described embodiments of the invention without departing from the true spirit and scope of the invention.

What is claimed is:

1. A location filtered messaging system, comprising:
a receiver to receive a message en route to a desired location, said message including at least one location characteristic included with said message by a sending wireless device before transmission;
a location filtering engine to extract said at least one location characteristic from said received message;
a filter to filter a proposed list of recipients of said message based on said extracted at least one location characteristic; and
determining a formal list of recipients of said message comprised of said filtered proposed list of recipients;
whereby location-based message distribution is provided.

2. The location filtered messaging system according to claim 1, wherein:
said at least one location characteristic is included in a message destination field by said sending wireless device.

3. A method of filtering delivery of messages based on embedded location information, comprising:
extracting embedded location characteristics from a received message en route to a desired location; and
applying extracted location characteristics as a location filter against an identified set of potential recipients of said message.

4. The method of filtering delivery of messages based on embedded location information according to claim 3, comprising:
detecting configurable keyword identifiers defined to mark a start and a stop of a location characteristic portion of said given received message, said configurable keyword identifiers enabling location filtering to identify that said given received message contains embedded location characteristics.

5. The method of filtering delivery of messages based on embedded location information according to claim 3, wherein:
said proposed list of destination devices is filtered in light of a particular geographic location.

6. The method of filtering delivery of messages based on embedded location information according to claim 3, wherein:
said proposed list of destination devices is filtered in light of a particular point of interest (POI).

7. The method of filtering delivery of messages based on embedded location information according to claim 3, wherein:
said proposed list of destination devices is filtered in light of a defined geographic boundary centered at a particular geographic location.

8. A method of filtering delivery of messages based on embedded location information, comprising:
attaining a location for each destination device referenced in a proposed message distribution list for a given received message;
comparing said attained location information for each destination device against location characteristics extracted from said location filtered message in affiliation with said proposed message distribution list;
based upon said comparing, composing a formal message distribution list from said proposed message distribution list; and
transmitting said location filtered message to each device in said formal message distribution list;
whereby said formal message distribution list contains each mobile device referenced in said proposed distribution list, with a current physical location that satisfies a filtered location filter defined in said location filtered message.

9. The method of filtering delivery of messages based on embedded location information according to claim 8, further comprising:
detecting configurable keyword identifiers defined to mark a start and a stop of a location characteristic portion of said given received message, said configurable keyword identifiers enabling location filtering to identify that said given received message contains embedded location characteristics.

10. The method of filtering delivery of messages based on embedded location information according to claim 8, wherein:
said proposed list of destination devices is filtered in light of a particular geographic location.

11. The method of filtering delivery of messages based on embedded location information according to claim 8, wherein:
said proposed list of destination devices is filtered in light of a particular point of interest (POI).

12. The method of filtering delivery of messages based on embedded location information according to claim 8, wherein:
said proposed list of destination devices is filtered in light of a defined geographic boundary centered at a particular geographic location.
